(19) United States
(12) Patent Application Publication
(10) Pub. No.: US 2006/0119196 A1
(43) Pub. Date: Jun. 8, 2006

(54) Supporting structure for cooling jacket of motor/generator

(75) Inventors: Masaru Konishi, Fujisawa-shi (JP); Akihiko Sano, Tokyo (JP); Yoshitaka Miura, Yokohama-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/265,160

(22) Filed: Nov. 3, 2005

(30) Foreign Application Priority Data
Dec. 6, 2004 (JP) 2004-352777

(51) Int. Cl. H02K 3/24; H02K 5/18; H02K 9/00; H02K 5/20

(52) U.S. Cl. 310/64

(57) ABSTRACT

A motor/generator (1) comprises a cylindrical stator core (5) facing the outer periphery of a rotor (3) on the inner side of a case (2). Base plates (8) constituted by an electrical insulation material are laminated on both ends of the stator core (5). A plurality of coils (7) are wound on the laminated body comprising the stator core (5) and the base plates (8). A cooling jacket (6) is attached to each of the base plate (8) using engagement members (6F, 6G, 8D, 8E, 10, 15) in order to envelope the projection of the coil (7). The end planks (2B, 2C) of the case (2) hold and press the cooling jacket (6) toward the stator core (5). Consequently, without forming a flange in order to fix the cooling jacket (6), the cooling jackets (6) are secured at a predetermined position within the case (2).

### FIELD OF THE INVENTION

This invention relates to the support of a cooling jacket for a motor/generator.

### BACKGROUND OF THE INVENTION

JP 04-364343A (Patent No. 2716286) published by the Japan Patent Office in 1992 discloses a cooling jacket using a cooling liquid in order to cool a motor/generator.

A stator core of the motor/generator comprises a laminated body formed from ring-shaped steel plates each of which is provided with a plurality of teeth protruding towards the center thereof. The coils of the stator are wound on the teeth which are laminated at equal angular positions to form respective cores. Consequently a section of each coil projects in an axial direction from the end face of the stator core.

The cooling jacket covers each end face of the cylindrical stator core. The projecting section of the coils are housed in a ring-shaped space formed by the cooling jacket.

A supply port and a discharge port for cooling liquid are formed in the cooling jacket. The coils and stator core are directly cooled by the cooling liquid as a result of the cooling liquid circulating from the supply port to the discharge port through the ring-shaped space.

### SUMMARY OF THE INVENTION

The outer peripheral section of the cooling jacket comprises a flange. The cooling jacket is maintained in a predetermined position by plural bolts fixing the flange to a ring-shaped step formed on the cylindrical case of the motor/generator.

The radius of the case is increased by forming the ring-shaped step on the case. Furthermore since the flange is fixed to the step by the bolts, it is necessary to provide a space to tighten the bolts in the case. In other words, the internal radius of the case according to the prior art must be increased relative to the outer radius of the stator. As a result, the outer radius of the motor/generator is also increased.

It is therefore an object of this invention to support and fix a cooling jacket without the use of a flange.

In order to achieve the above object, this invention provides a motor/generator comprising a rotor having an outer periphery, a cylindrical stator core facing the outer periphery of a rotor and having two ends, a base plate laminated on an end of the stator core, plural coils wound on a laminated body comprising the stator core and the base plate, a cooling jacket attached to the base plate, a cooling liquid being supplied to the cooling jacket, and a case housing the cooling jacket and the stator core, and holding the cooling jacket in a state pressed towards the stator core.

The details as well as other features and advantages of this invention are set forth in the remainder of the specification and are shown in the accompanying drawings.

### BRIEF DESCRIPTION OF THE DRAWINGS

FIG. 1 is a schematic longitudinal sectional view of a motor/generator showing a support structure of a cooling jacket according to this invention.

FIG. 2 is a longitudinal sectional view of a stator core with the cooling jacket.

FIG. 3 is a plan view of a base plate according to this invention.

FIG. 4 is a schematic exploded perspective view of the stator core including the base plate.

FIG. 5 is a schematic perspective view of essential parts of the cooling jacket.

FIG. 6 is an enlarged longitudinal sectional view of the main components of the motor/generator showing the cooling jacket in a supported state.

FIG. 7 is a longitudinal sectional view of a cooling jacket according to a second embodiment of this invention.

FIG. 8 is an enlarged longitudinal sectional view of the main components of a motor/generator for showing the cooling jacket in a supported state according to the second embodiment of this invention.

FIGS. 9A-9C are a side view, a front view and a rear view of an adaptor according to the second embodiment of this invention.

FIGS. 10A and 10B are sectional views of the adapter respectively cut along the lines XA-XA and XB-XB in FIG. 9B.

FIG. 11 is an enlarged perspective view of a base plate according to the second embodiment of this invention for showing fitting of the adapter thereto.

FIG. 12 is an enlarged perspective view of the base plate according to the second embodiment of this invention for showing fitting of the cooling jacket on the base plate using the adaptor.

### DESCRIPTION OF THE PREFERRED EMBODIMENTS

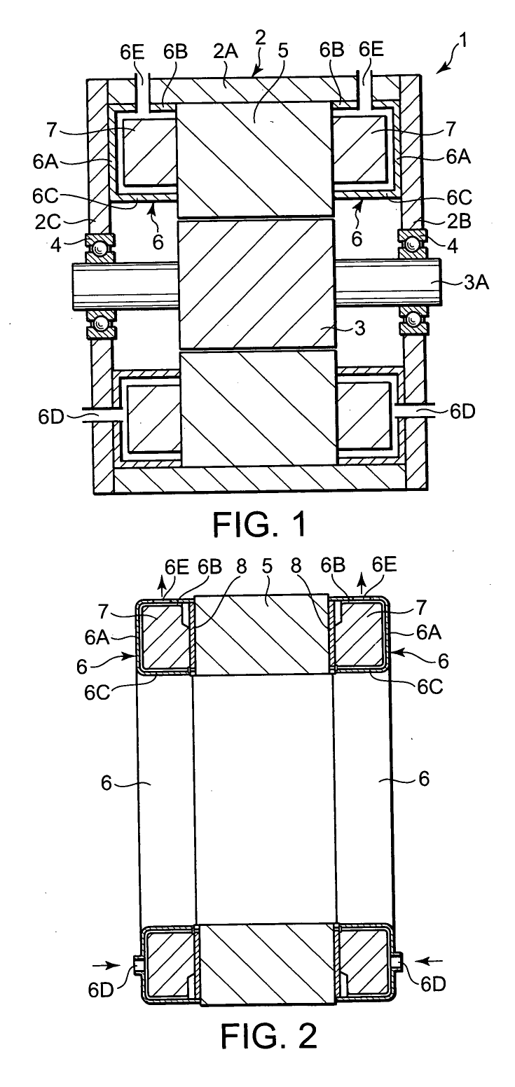

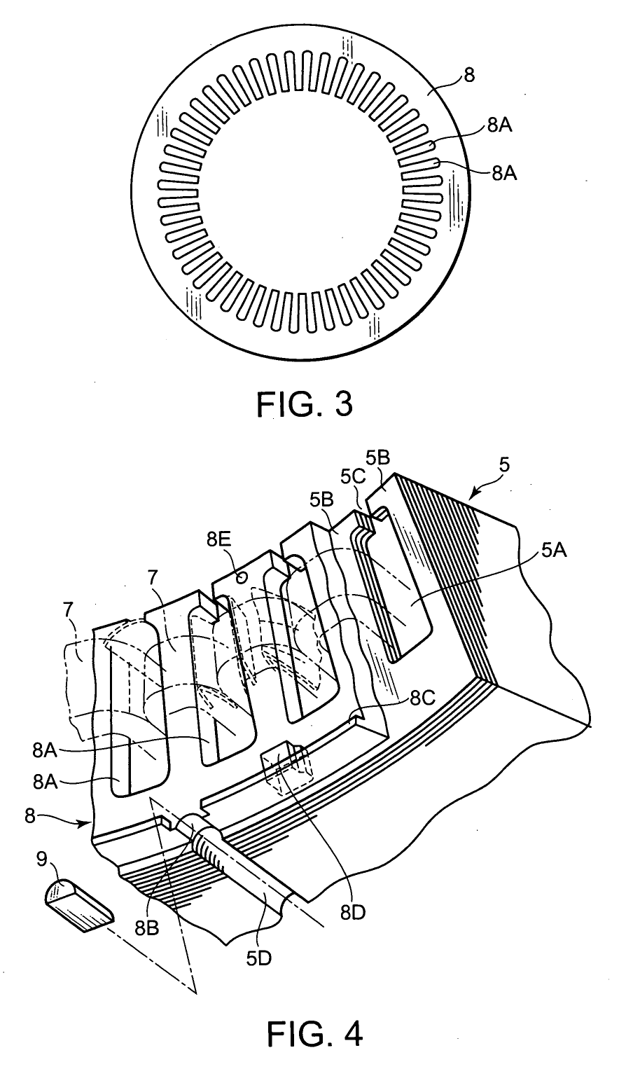

Referring to FIG. 1 of the drawings, a motor/generator 1 comprises a cylindrical stator core 5 housed in a case 2, a plurality of stator coils 7 formed on the stator core 5, and a rotor 3 disposed on the inner side of the stator core 5.

The case 2 comprises a cylinder 2A and end planks 2B, 2C sealing both ends of the cylinder 2A. The stator core 5 is fixed to the inner peripheral face of the cylinder 2A.

The rotor 3 comprises a rotation shaft 3A. Both ends of the rotation shaft 3A are supported to rotate freely on the end planks 2B, 2C by respective bearings 4. The rotor 3 is disposed with a predetermined gap in a coaxial position with respect to the stator core 5.

A pair of U-shaped cross section cooling jackets are respectively fitted on both end faces with respect to the axial direction of the stator core 5. The cooling jackets 6 are constituted from an electrical insulation material and create a ring-shaped space facing the stator core 5. Referring now to FIG. 2, each cooling jacket 6 comprises an oil supply port 6D opened in an axial direction and an oil discharge port 6E opened in a radial direction.

Referring now to FIG. 4, the stator core 5 comprises laminated ring-shaped steel plates with a plurality of teeth 5B projecting to the center to allow winding of wire rod. In this motor/generator 1, a base plate 8, the shape of which is identical to that of the ring-shaped steel plate, is further laminated on each end face of the stator core 5. Hereinafter, the stator core 5 with the base plate 8 laminated on each end face is referred to as a laminated body. Coils 7 are wound on the laminated body, specifically on the teeth 5B and the corresponding portions of the base plates 8. A slot 5A is formed in order to house the coils 7 between adjacent teeth 5B on the laminated body. Winding of the coils 7 are performed via an insulating sheet so that the coils 7 and the teeth 5B do not come into direct contact. In this manner, a part of both ends of the coils wound onto the teeth 5B and the corresponding portions of the base plates 8 project away from the axis from the laminated body as shown in FIGS. 1 and 2. The pair of cooling jackets 6 are fitted to the laminated body so that the projecting sections of the coil 7 are covered. The openings 5C of each slot 5A are closed as described hereafter.

When the motor/generator 1 is operated, cooling oil supplied to the oil supply port 6D of each cooling jacket 6 cools the end face of the laminated body and the projecting section of the coil 7 and thereafter is discharged from the oil discharge port 6E. It is preferred that the oil supply port 6D and the oil discharge port 6E are positioned such that the oil supply port 6D is in a lower section and the oil discharge port 6E is in an upper section when the motor/generator is secured. Such a positional relationship allows cooling oil supplied to the cooling jacket 6 from the oil supply port 6D to fill the cooling jacket 6 and the slot 5A without leaving any space while air in the inner section is discharged from the oil discharge port 6E by the rising level of liquid. As a result, the cooling oil displays conspicuously high cooling performance.

The method of fitting the cooling jacket 6 onto the laminated body will now be described.

As described above, in this motor/generator 1, the coils 7 are wound on the laminated body, i.e., the stator core 5 covered by the base plates 8. The base plate 8 comprises thin plate made of an electrical insulating material.

Referring now to FIG. 4, the base plate 8 comprises a plurality of engagement holes 8E formed at an equal angular intervals on the inner peripheral section. The base plate 8 further comprises a plurality of engagement indentations 8D on the outer peripheral section at the same rotational positions as the engagement holes 8E. The base plate 8 further comprises a ring-shaped rim 8C projecting in an axial direction on the outer periphery. The open end of the cooling jacket 6 is inserted into the inner side of the rib 8C, radial deformation of the cooling jacket 6 is thereby prevented by the rib 8C.

Positioning grooves 8B engaging with positioning keys 9 are formed on the outer periphery of the base plate 8. Similar positioning grooves 5D are also provided on the outer periphery of the stator core 5. The base plate 8 is laminated on the stator core 5 so that the positioning grooves 8B correspond with the positioning grooves 5D. The positioning keys 9 are provided as part of a jig determining the rotational angle of the base plate 8 and the ring-shaped steel plates when the base plate 8 is laminated with the ring-shaped steel plates of the stator core 5, or when the winding operation for the coils 7 is performed on these components. The keys 9 do not constitute a component of the motor/generator 1.

It is noted that the prior art also comprises an insulation plate formed from an electric insulation material in place of the base plate 8 in order to prevent contact between the metal components of the stator core 5 and the windings of the coils 7. This invention uses a base plate 8 formed from the same electric insulation material instead of the insulation plate. Therefore the assembly operation of the motor/generator 1 is not complicated by the addition of the base plate 8.

After the winding operation of the coils 7 is completed, the slot 5A is sealed using a thermosetting resin to seal the openings 5C of the slot 5A. In order to introduce the resin into the slot 5A without making contact with the coil 7, it is preferred that a plate is provided across the slot 5A between the adjacent teeth 5B in order to isolate the slot 5A from the resin poured into the opening 5C.

A portion of the coil 7 protrudes in an axial direction from the slot 5A as described above. The protruding end is housed in the cooling jacket 6 after being reshaped as shown in FIG. 6.

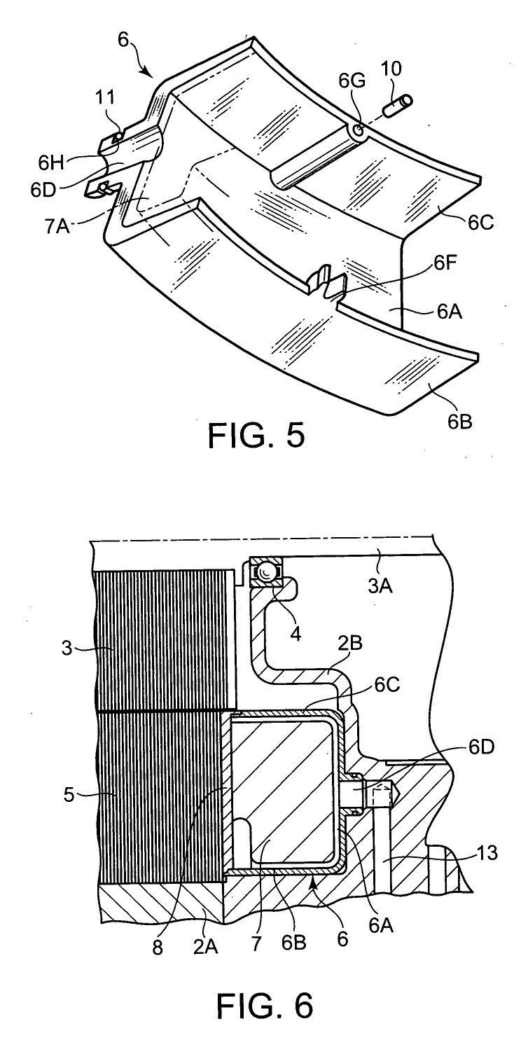

Referring now to FIG. 5, the cooling jacket 6 has a U-shaped cross section comprising an inner peripheral wall 6C and an outer peripheral wall 6B on both sides of a base wall 6A. Although the cooling jacket is shown in a cut-off state in order to facilitate description, the cooling jacket 6 is formed as a continuous ring-shaped member.

Engagement holes 6G are provided in the inner peripheral wall 6C in positions corresponding to the engagement holes 8E described above. Further, engagement projections 6F are provided in the outer peripheral wall 6B in positions corresponding to the engagement indentations 8D described above. When the cooling jacket 6 is attached to the stator core 5 via the base plate 8, an end of a pin 10 is inserted into the engagement hole 6G. The other end of the pin 10 is pre-inserted into the engagement hole 8E. The engagement projection 6F is inserted into the engagement indentation 8D. In this manner, the cooling jacket 6 is fixed to the stator core 5. The engagement projection 6F comprises an elastically deforming member which is inserted into the engagement indentation 8D in a manner allowing elastic deformation and is fixed therein by expanding due to elastic force. The engagement projection 6F is integrated with the cooling jacket 6 beforehand using injection molding.

Before attaching the cooling jacket 6 to the laminated body, a sealant is applied to the face of the base plate 8 abutting with the cooling jacket 6. When assembling the motor/generator 1, the laminated body is fixed in the cylinder 2A of the case 2 with the cooling jacket 6 attached to both ends. The end planks 2B and 2C are fixed to the cylinder 2A using a bolt. When the bolt is tightened, the pair of cooling jackets 6 are pressed onto the stator core 5 by the end planks 2B and 2C. The interaction of the pressing action and the applied sealant ensures the sealing of the cooling jacket 6. Referring to FIG. 6, a supply passage 13 for supplying cooling oil is formed in the oil supply port 6D of the end planks 2B and 2C.

In order to describe the structure of the motor/generator 1 schematically, the end planks 2B and 2C are shown in a simple flat shape. However the end planks 2B and 2C actually comprise a cylindrical section connected with the cylinder 2A abutting with the outer peripheral wall 6B of the cooling jacket 6 as shown in FIG. 6. In FIG. 1, although the outer peripheral wall 6B of the cooling jacket 6 is depicted as it only abuts with the cylinder 2A, the outer peripheral wall 6B abuts also with the cylindrical section formed on the end planks 2B and 2C as shown in FIG. 6. A seal ring 11 is attached to the outer periphery of the oil supply port 6D in order to prevent oil in the cooling jacket 6 from leaking through a gap between the end planks 2B (2C) and the oil supply port 6D. As shown in FIG. 1, it is possible to design the motor/generator 1 such that the outer peripheral wall 6B of the cooling jacket 6 abuts with the cylinder 2A as depicted in FIG. 1.

The cooling jacket 6 having the above structure is fitted to the stator core 5 via the base plate 8 using the positioning pins 10 and the positioning projections 6F and is bonded on the stator core 5 in an axial direction by the end planks 2B and 2C.

Therefore this embodiment enables a reduction in the diameter of the case 2, in comparison to the prior art in which a flange is provided on the cooling jacket and a step is formed on the inner periphery of the case for the purpose of positioning and fixing of the cooling jackets on the stator core. Furthermore the supporting structure for the cooling jacket is simplified and assembly operations are facilitated in this embodiment.

In this embodiment, cooling oil passes through the slot 5A. On the other hand, it is possible to arrange the cooling jacket 6 so that the slot 5A is sealed with respect to the cooling jacket 6 and cooling oil in the cooling jacket 6 only cools the end face of the laminated body and the coil protruding from the slot 5A into the cooling jacket 6. In this case, the sealing operation on the opening 5C of the slot 5 can be omitted.

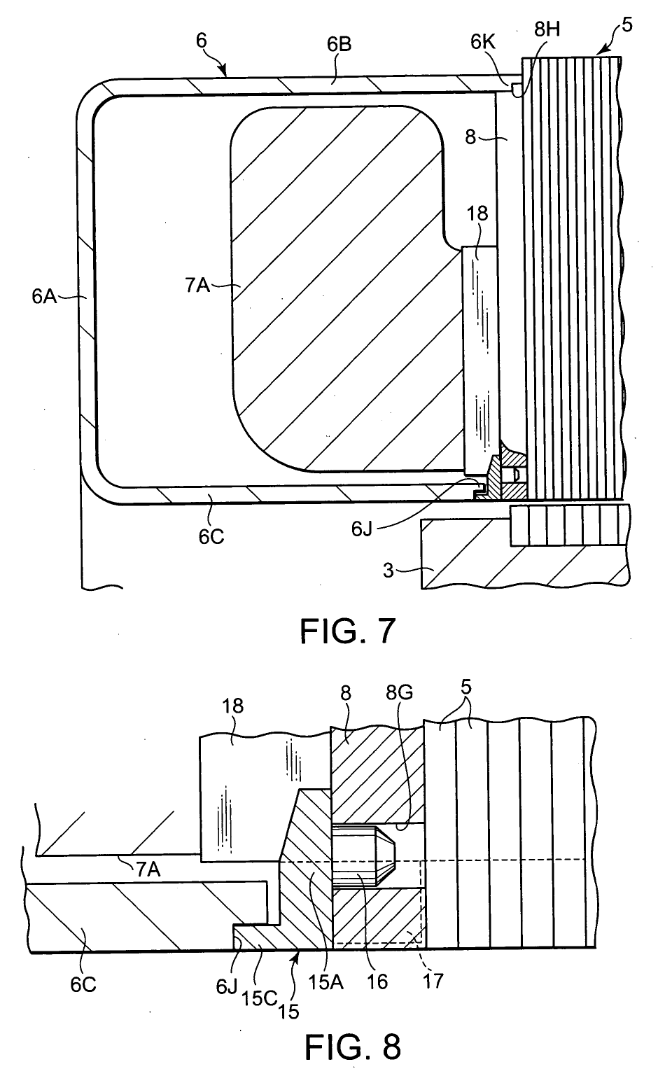

Referring to FIGS. 7-11, a second embodiment of this invention will be described. Members which are the same as those described with reference to the first embodiment have been designated by the same reference numerals and additional description will be omitted.

In this embodiment, adapters 15 are used in order to mount the cooling jacket 6 on the base plate 8.

Referring to FIGS. 7 and 8, the adapters 15 are mounted on the inner peripheral section of the base plate 8. The adapter 15 comprises a cylindrical wall face 15C projecting in an axial direction from the edge of the inner periphery of the base plate 8. Deformation of the inner peripheral wall 6C towards the center is limited since the wall face 15C abuts with the tip of the inner peripheral wall 6C of the cooling jacket 6 from the direction of the rotation shaft 3A. For this purpose, a step 6J engaging with the wall face 15C is formed on the tip of the inner peripheral wall 6C of the cooling jacket 6.

A step 8H is formed on the outer periphery of the base plate 8. A step 6K having the same shape as the step 8H is also provided on the inner side of the tip of the outer peripheral wall 6B of the cooling jacket 6. The tip of the outer peripheral wall 6B of the cooling jacket 6 engages with the outer periphery of the base plate 8 such that the steps 8H and 6K mesh with each other. When the motor/generator 1 is assembled, the cylindrical section of the end plank 2B (2C) or the cylinder 2A of the case 2 abuts with the outer peripheral wall 6B and prevents the outer peripheral wall 6B from deforming outwardly as a result of the hydraulic pressure of the cooling oil.

The cooling jacket 6 is attached to the stator core 5 by the engagement of the inner peripheral wall 6C with the cylindrical wall face 15C and the engagement of the outer peripheral wall 6B with the outer periphery of the base plate 8. In contrast to the first embodiment, the cooling jacket 6 in this embodiment does not comprise the engagement holes 6G for accommodating the pins 10 or the engagement projections 6F, and the cooling jacket 6 is attached to the stator core 5 without using these components. However at least one of the engagement of the inner peripheral wall 6C with the peripheral wall 15C or the engagement of the outer peripheral wall 6B with the outer periphery of the base plate 8 is placed in a state of tight engagement accompanying some elastic deformation. Due to this arrangement, during the assembly process of the end planks 2B and 2C of the case 2 for fixing the cooling jackets 6 to the laminated body, it is possible to prevent the cooling jackets 6 from detaching from the laminated body. In other respects, the construction of the cooling jacket 6 are the same as those described with reference to the first embodiment.

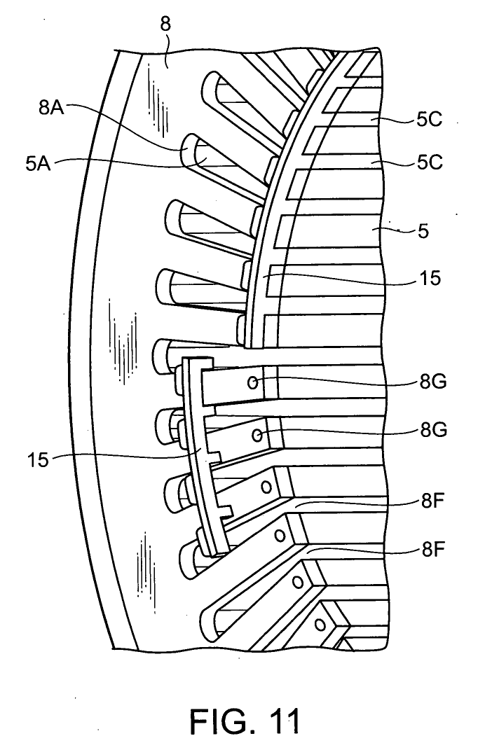

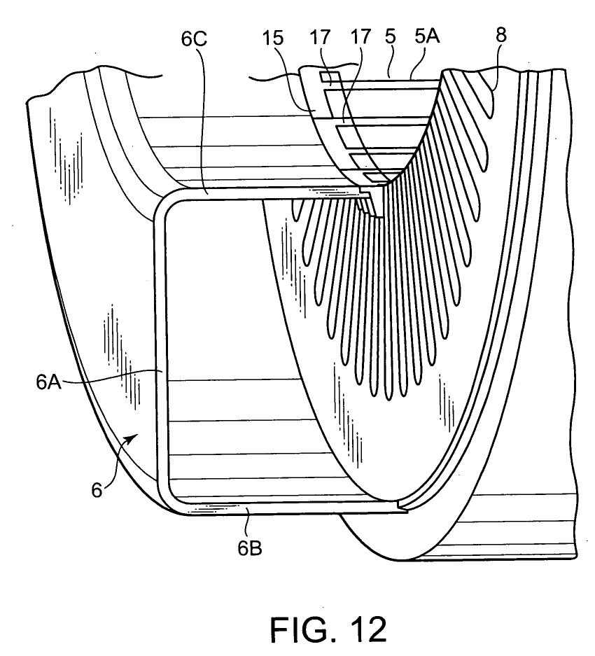

Referring to FIGS. 11 and 12, the adapter 15 is an arch-shaped member mounted on the inner peripheral section of the base plate 8. The arches form a circle as a result of placing a plurality of adapters 15 next to each other on the inner peripheral section of the base plate 8.

A slot 8A superimposed on the slot 5A of the stator core 5 in an axial direction is formed on the base plate 8. An opening 8F is formed in the same manner at a position superimposed with the opening 5C.

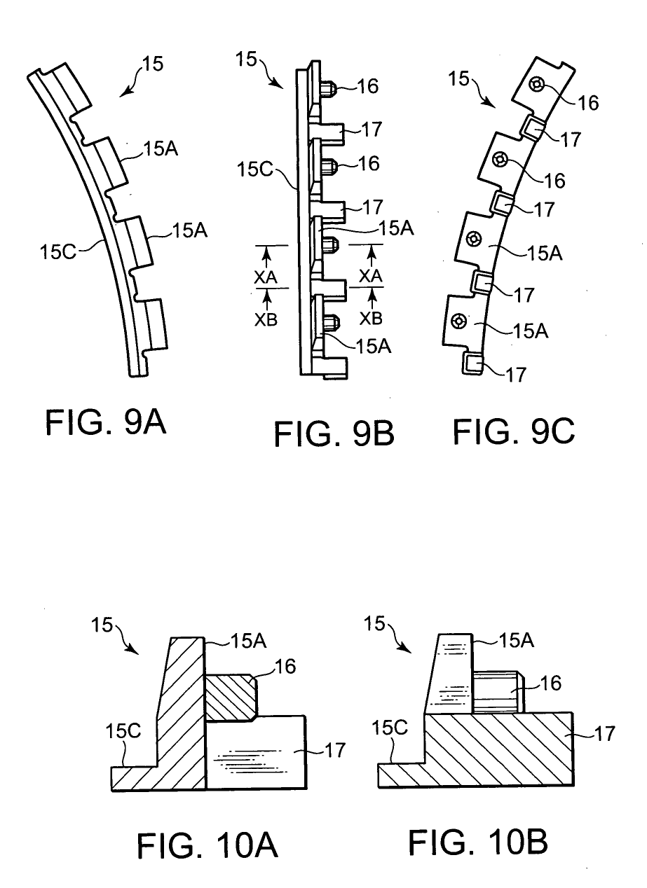

Referring now to FIGS. 9A-9C and FIGS. 10A-10B, the adaptor 15 comprises a plurality of bar-shaped projections 17, flanges 15A and a cylindrical wall face 15C. The projections 17 are formed at equal intervals in order to be inserted into the opening 8F. The flanges 15A are formed between the projections 17 and superimposed with the inner peripheral section of the base plate 8 between the projections 17. As shown in the figures, the cylindrical wall face 15C is formed across the entire length of the arch of the adapter 15. Engagement pins 16 projecting towards the base plate 8 are formed on the respective flanges 15A.

Engagement holes 8G allowing insertion of the engagement pins 16 are formed on the base plate 8 as shown in FIG. 11. The engagement hole 8G is formed at substantially the same position as the engagement hole 8E formed on the base plate 8 in the first embodiment. The engagement indentation 8D formed on the base plate 8 in the first embodiment is not provided in this embodiment. In other respects, the base plate 8 is the same as that described with respect to the first embodiment.

The assembly operation for the motor/generator 1 will now be described.

The winding operation of the coils 7 on the base plate 8 and the stator core 5 is the same as that described with reference to the first embodiment. The portion of the coil 7 that protrudes from the laminated body in the axial direction may be impregnated with electrical insulation material and thereafter processed with heat.

The sealing operation using thermosetting resin on the openings 5C is the same as the operation used in the first embodiment. However in this embodiment, after the rod-shaped projection 17 is inserted into the opening 8F of the base plate 8, thermosetting resin is poured into the opening 5C. In other words, after the adapter 15 is mounted on the base plate 8, the opening 5C is sealed using thermosetting resin. Consequently the thermosetting resin used to seal the opening 5C does not prevent the rod-shape projections 17 from entering the openings 8F of the base plate 8.

The adapter 15 is attached to the base plate 8 by respectively inserting the positioning pins 16 into the engagement holes 8G of the base plate 8 and the bar-shaped projections 17 into the openings 8C of the base plate 8. If these inserted sections are adapted to have dimensions allowing tight engagement, it is possible to prevent the adapter 15 from detaching from the base plate 8. In FIG. 11, the adapter 15 in the lower section of the figure is shown during attachment, and the adapter 15 in the upper section of the figure is shown as attached. Before attachment of the adapter 15, sealant is pre-applied to the contact face of the adapter 15 and the base plate 8.

The coil 7 and the stator core 5 are electrically insulated using an insulation sheet in the same manner as the first embodiment. As shown in FIGS. 7 and 8, the end of the insulation sheet 18 projects into the cooling jacket 6. When the adapter 15 is attached, the inner face of the two adjacent flanges 15A and the rod-shaped member 17 positioned therebetween form a U-shaped groove. In the base plate 8, the U-shaped groove prevents deformation of the windings of the coil 7 in the direction toward the rotation shaft 3A.

Referring now to FIG. 12, after the adapter 15 is attached across the entire periphery of the base plate 8, the cooling jacket 6 is attached to the base plate 8 via the adapters 15.

Herein, the tip of the inner peripheral wall 6C of the cooling jacket 6, i.e., the thin portion made by the step 6J is inserted into the inner side of the cylindrical wall face 15C of the adapters 15. On the other hand, the step 6K on the tip of the outer peripheral wall 6B is engaged with the step 8H of the outer periphery of the base plate 8. In the figure, the coil 7 is omitted for a better description of the attaching state of the cooling jacket 6 to the adapter 15. However in reality, as shown in FIG. 7, a portion of the coil 7 protrudes into the cooling jacket 6 from the laminated body. Sealant is applied to the abutting sections of the wall face 15C and the step 6J as well as to the abutting sections between the steps 6K and 8H before attachment of the cooling jacket 6.

In this manner, the pair of cooling jackets 6 is attached to the stator core 5 via the adapters 15. In this state, the openings 5C of each slot 5A of the stator core 5 are sealed by thermoplastic resin and the rod-shaped projection 17 is engaged with the opening 8F of the base plate 8. Thus the slots 5A are isolated from the space for the rotation of the rotor 3 and communicate only with the cooling jackets 6 on the both sides via the slots 8A formed in the base plates 8.

In this state, the laminated body and the cooling jackets 6 are fixed inside the case 2 and the end planks 2B and 2C are fixed to the cylinder 2A using plural bolts as in the case of the first embodiment. The end planks 2B and 2C press the cooling jackets 6 onto the laminated body as the bolts are tightened in the same manner as the first embodiment. The sealing of the cooling jackets 6 is ensured by the interaction of the sealant and the tightening force of the bolts in the same manner as the first embodiment.

In this manner, when the assembled motor/generator 1 is operated, cooling oil circulates in the slots 5A of the stator core 5 and the two cooling jackets 6 in the same manner as the first embodiment in order to cool the motor/generator 1. The deformation pressure of the oil pressure acts on the outer peripheral wall 6B and the inner peripheral wall 6C of the cooling jacket 6. The cylindrical wall face 15C of the adaptor 15 supports the tip of the inner peripheral wall 6C against the oil pressure and prevents the deformation of the tip of the inner peripheral wall 6C. Furthermore oil leaks are prevented as a result of the attachment of the cylindrical wall face 15 to the tip of the inner peripheral wall 6C. On the other hand, the cylindrical section formed on the end planks 2B and 2C as shown in FIG. 6 or the cylinder 2A of the case 2 come into contact with the outer periphery of the outer peripheral wall 6B and prevent deformation of the outer peripheral wall 6B. Furthermore oil leaks are prevented by the sealant between the steps 6K and 8H.

This embodiment also allows the radius of the case 2 to be reduced in comparison to the prior art examples in which a flange is provided in the cooling jacket and fixed to the case 2 in order to support and fix the cooling jacket. Furthermore the supporting structure for the cooling jacket is simplified and assembly operations are facilitated.

In each of the above embodiments, the engagement projection 6F, the engagement hole 6G, the engagement indentation 8D, the pin 10 and the adapter 15 fix the cooling jacket 6 with respect to the base plate 8 and play a role in preventing the detachment of the cooling jacket 6 from the base plate 8. These members correspond to the engagement members referred to in the Claims.

The contents of Tokugan 2004-352777, with a filing date of Dec. 6, 2004 in Japan, are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

For example, in the above two embodiments, although the respective cooling jackets 6 are attached to both ends of the laminated body this invention can be applied to a motor/generator in which the cooling jacket 6 is disposed only on one end of the laminated body.

The embodiments of this invention in which an exclusive property or privilege is claimed are defined as follows:

What is claimed is:

1. A motor/generator comprising:
a rotor having an outer periphery;
a cylindrical stator core facing the outer periphery of a rotor, the cylindrical stator core having two ends;
a base plate laminated on an end of the stator core;
plural coils wound on a laminated body comprising the stator core and the base plate;
a cooling jacket attached to the base plate, a cooling liquid being supplied to the cooling jacket; and
a case housing the cooling jacket and the stator core, and holding the cooling jacket in a state pressed towards the stator core.

2. The motor/generator as defined in claim 1, wherein the stator core has two ends in an axial orientation, and the base plate and the cooling jacket are both disposed on the two ends of the stator core.

3. The motor/generator as defined in claim 1, wherein the coil comprises a projection projecting from the base plate in an axial direction, and the cooling jacket is adapted to envelope the projection.

4. The motor/generator as defined in claim 1, wherein the base plate comprises an electrically insulating member having the same shape as the cross-sectional shape of the stator core.

5. The motor/generator as defined in claim 1, wherein the case comprises a cylinder covering the outer periphery of the cooling jacket, and two end planks sealing both ends of the cylinder, the end planks being fixed to the cylinder so as to press the cooling jackets towards the stator core.

6. The motor/generator as defined in claim 5, wherein sealant is applied to the abutting sections of the cooling jacket and the base plate.

7. The motor/generator as defined in claim 1, wherein the cooling jacket is fitted to the base plate via engagement members which fit the cooling jacket to the base plate at a predetermined position and prevent the cooling jacket from detaching from the base plate.

8. The motor/generator as defined in claim 7, wherein the engagement members comprise a connecting projection and a engagement indentation, the connecting projection capable of elastic deformation and formed in the cooling jacket, the engagement indentation formed on the base plate and adapted to accommodate the connecting projection after the connecting projection undergoes elastic deformation and prevent thereafter the connecting projection from detaching from the base plate.

9. The motor/generator as defined in claim 7, wherein the cooling jacket comprises an inner peripheral wall, and the engagement members comprise an adapter comprising a cylindrical wall face which is fixed to the inner peripheral section of the base plate and which abuts with the tip of the inner peripheral wall in a direction from the center of the base plate.

10. The motor/generator as defined in claim 9, wherein the adapter comprises a plurality of pieces partitioned in a circumferential direction.
